(19) United States
(12) Patent Application Publication
(10) Pub. No.: US 2003/0175183 A1
(43) Pub. Date: Sep. 18, 2003

(54) Tubular reactor for carrying out exothermic gas phase reactions

(76) Inventor: Friedrich Guetlhuber, Metten (DE)

Correspondence Address: Karl F Milde Jr, Milde & Hoffberg, Suite 460, 10 Bank Street, White Plains, NY, 10606, US

(21) Appl. No.: 10/275,204

(22) PCT Filed: May 4, 2001
(86) PCT No.: PCT/EP01/05030

(30) Foreign Application Priority Data
May 5, 2000 (DE) 100-21-986.1

(51) Int. Cl. B01J 8/04

(52) U.S. Cl. 422/196

(57) ABSTRACT

A tube reactor (2) for performing exothermic gas phase reactions comprising a reaction tube bundle (8), that extends in a sealed manner between two tube end plates (4, 6), that carries a reaction gas and is surrounded by a heat carrier inside a surrounding reactor shell (10). The tube reactor also includes a cowl (18, 20) that spans the respective tube plates (4, 6) and is connected to a gas inlet and a gas discharge line, respectively. Inside the cowl (18) on the gas inlet side adjacent to a first gas supply chamber (28), connected to the inside of the reaction tubes (16), is located a separately fed second gas supply chamber (30) with its own tube end plate (32) that is connected to separate gas supply tubes (34) suitable for a second reaction gas. The separate gas supply tubes reach into the gas inlet end or reach to directly before the gas inlet ends of the reaction tubes (16). This avoids early admixing of an explosion-critical reactant into the reaction gas stream using relatively simple and practical means of construction, which in turn improves the ability to load the reaction gas stream with this reactant.

The invention relates to a tubular (“tube”) reactor according to the main subject of patent claim 1.

Such tube reactors are used for a variety of chemical reaction processes; among them, the catalytic oxidation of hydrocarbons such as for the production of ethylene oxide or acetic acid, for example. In this case, the reaction occurs in a circulating process, for example, where fresh reaction gas is continuously added prior to entering the reactor and the material streams to be discharged from the reactor are separated. The yield per pass and thus the size of the reactor including the associated aggregates such as pumps, blowers and the like as well as those of the required drive power depend essentially on the efficiency of the reaction and thus, in turn, on the mixing ratio of the reactants. However, this ratio is restricted by the controllability of the generated amount of reaction heat and in some cases the risk of burn-off or even of explosion. Thus, with conventional methods one is often forced, for example, to limit the O₂ portion at the reactor inflow to a few percent. Similar problems exist, for example, when producing phthalic anhydride, maleic anhydride, acrolein and acrylic acid.

Through various measures, the loading of the reaction gas mixture with a critical component, such as O₂, for example, has already been increased by controlling the temperature that adjusts itself along the contact tubes in a desired manner via the heat carrier circuit. Such measures can be obtained, for example, from DE-C-2 201 528, where the reactor may be separated into several successive sections with more or less separate heat carrier circuits, and if applicable, even with different catalyst fillings, and where additionally varying baffle plates and/or manifold plates may be used. Furthermore, it has already been recommended to feed at least a portion of the critical component little by little in the course of the reaction process, for example, by using separate gas supply tubes that extend through the reaction tubes and that incorporate scattered or also discrete consecutive gas discharge locations (Tonkovich et al. “Inorganic Membrane Reactors for the Oxidative Coupling of Ethane” Chem. Engineering Science, Vol. 51, No. 11, 1996, P. 3051-3056, or U.S. Pat. No. 5,723,094). Such gas supply tubes are, of course, difficult to realize, especially in industrial applications, not only with respect to a desirable gas discharge distribution along the length of the tube, but also, as concerns the gas supply, to a multitude of such gas supply tubes that may number 10,000 or even more for an industrial tube reactor.

Therefore, the objective of the invention according to the main subject of patent claim 1 is to find a rational way to increase the possibility of loading ignition or even explosion critical components into the reaction gas mixture for a tube reactor of the conventional type.

This objective is essentially achieved by the main features of patent claim 1. The sub-claims provide advantageous design capabilities or also additional measures.

The respective short gas supply tubes in connection with the accompanying gas supply chamber within the gas entry cowl enable the feed-in of an ignition- or explosion-critical reaction gas component only just prior to the desired reaction, and to quickly cut off the supply of this component in case of an ignition or explosion, for example, in case of a control error, especially if the gas supply chamber has a small volume, and thus, to limit the spread of the fire in the reactor, and especially to keep the resulting pressure increase within the reactor to a minimum and easily controllable. This also spares the sealing problems associated with the wall bushings for the gas supply tubes as are expected according to U.S. Pat. No. 5,723,094. In addition, the gas supply tubes with the gas supply chamber can be removed according to the invention, so as not to impede the filling of the reaction tubes with catalysts.

Feeding a second reactant into the reaction tubes of a tube reactor via supply tubes that end in the gas supply end of the reaction tube is already known otherwise, for example, from U.S. Pat. No. 4,221,763; however, this deals only with a small number of individual tubes that pass through the gas inlet cowl and need to be sealed at the inlet area, where said tubes may be used for carbon dust injection. In a similar fashion, gas supply tubes that end in reaction tubes are used for several reformers (WO97/05947) or also for mixing gases with liquids in so-called falling film reactors (e.g., U.S. Pat. No. 5,445,801).

The following describes in greater detail some advantageous exemplary embodiments and design possibilities of the invention using drawings, of which

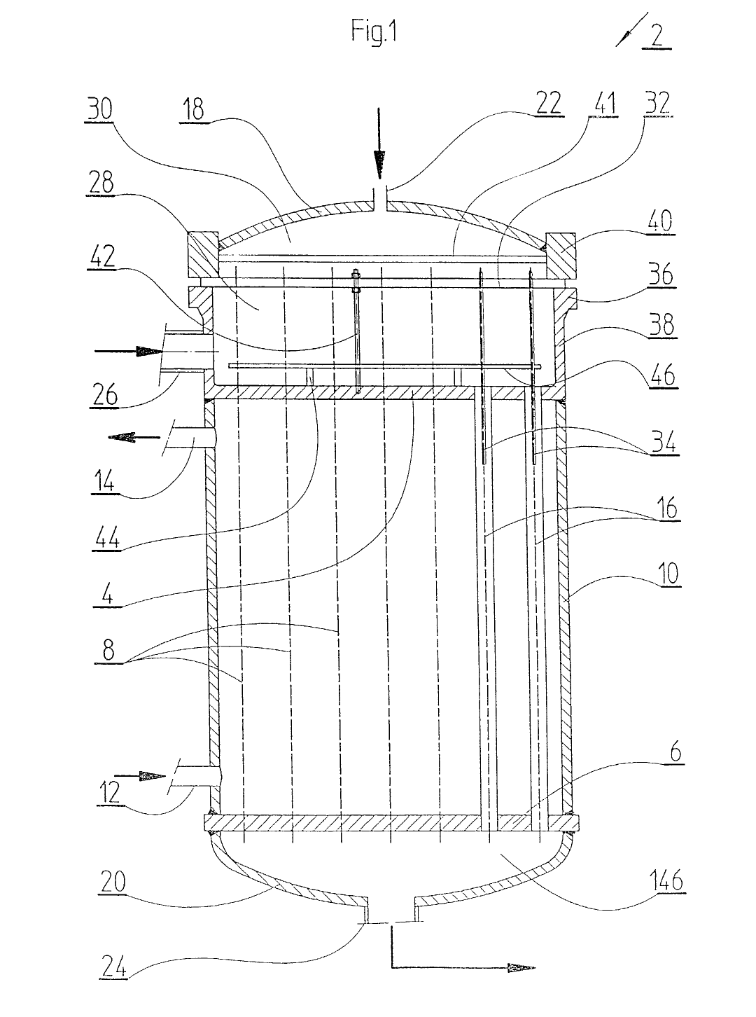

FIG. 1 shows a schematic longitudinal section through a tube reactor according to a first exemplary embodiment of the invention,

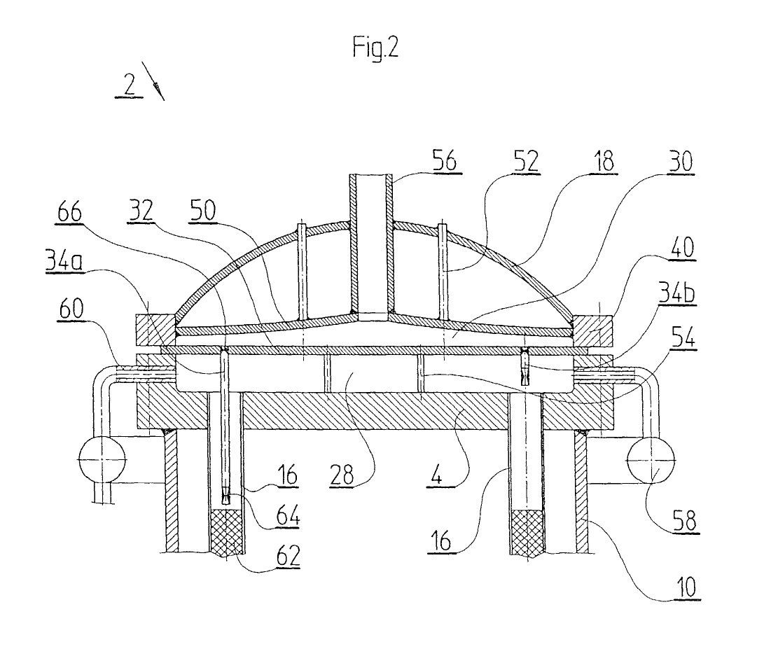

FIG. 2 shows a schematic longitudinal section through the gas inlet area of a tube reactor according to another embodiment of the invention,

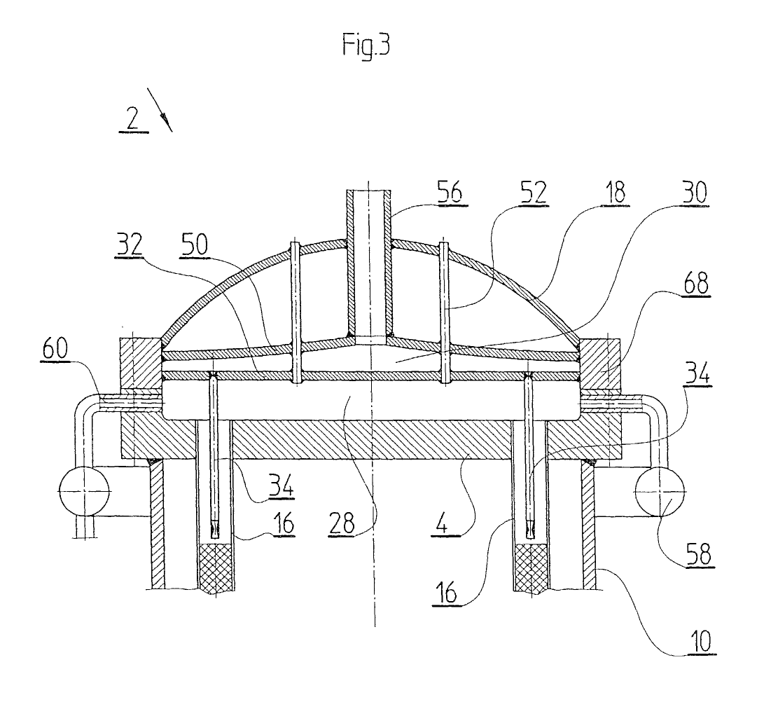

FIG. 3 shows a similar longitudinal section according to a third exemplary embodiment of the invention,

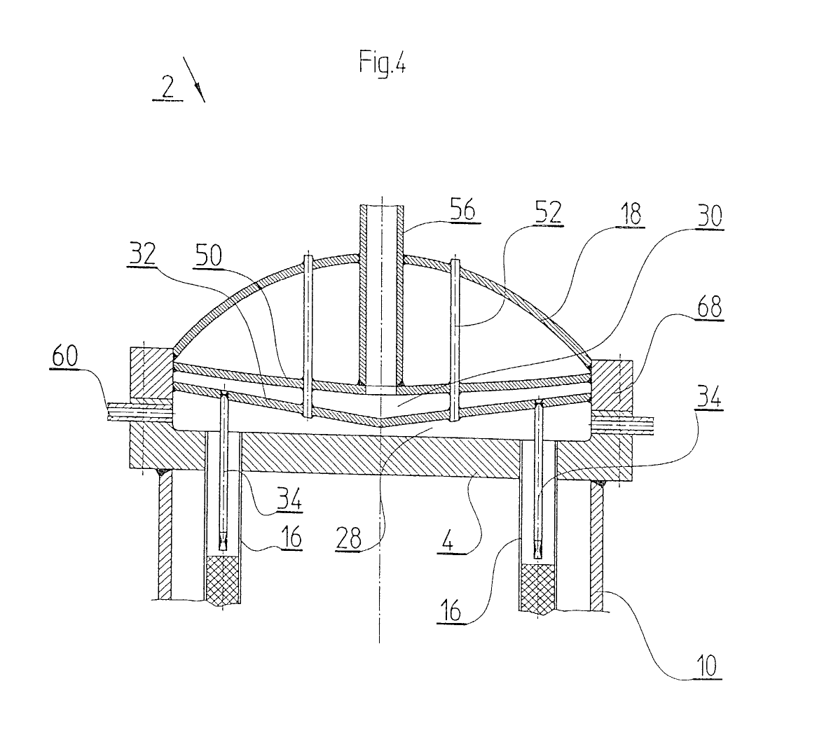

FIG. 4 shows a similar longitudinal section according to a fourth exemplary embodiment of the invention,

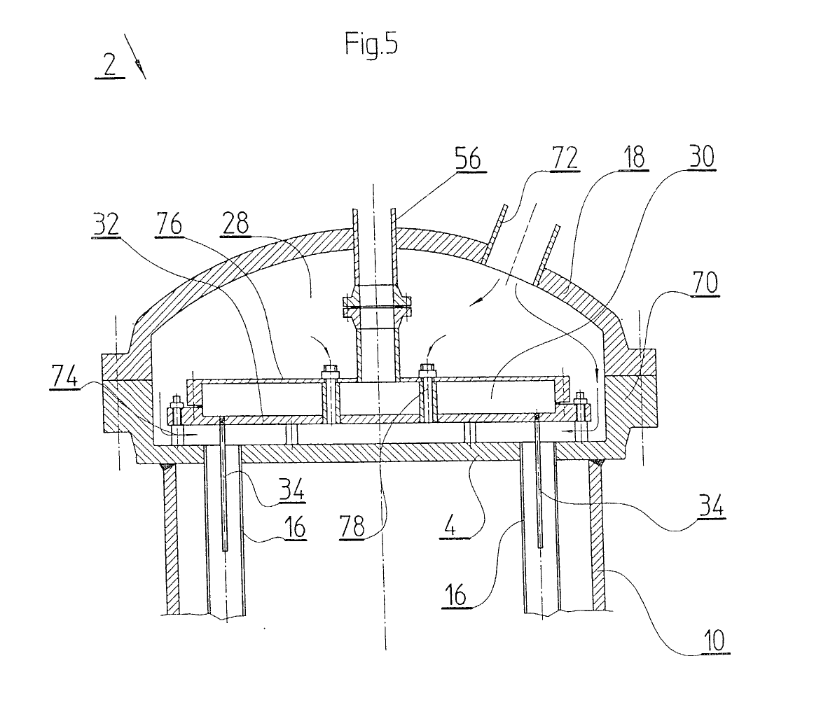

FIG. 5 shows a similar longitudinal section according to a fifth exemplary embodiment of the invention,

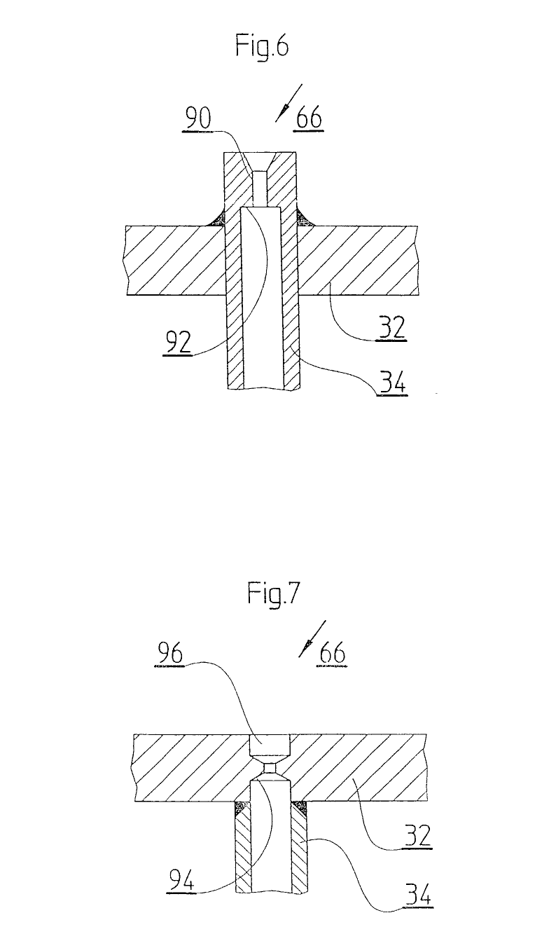

FIG. 6 shows, greatly enlarged, an exemplary design of the gas inlet to the gas supply tubes according to the invention together with their connection to the respective tube plate,

FIG. 7 shows another exemplary embodiment of the gas inlet to the gas supply tubes,

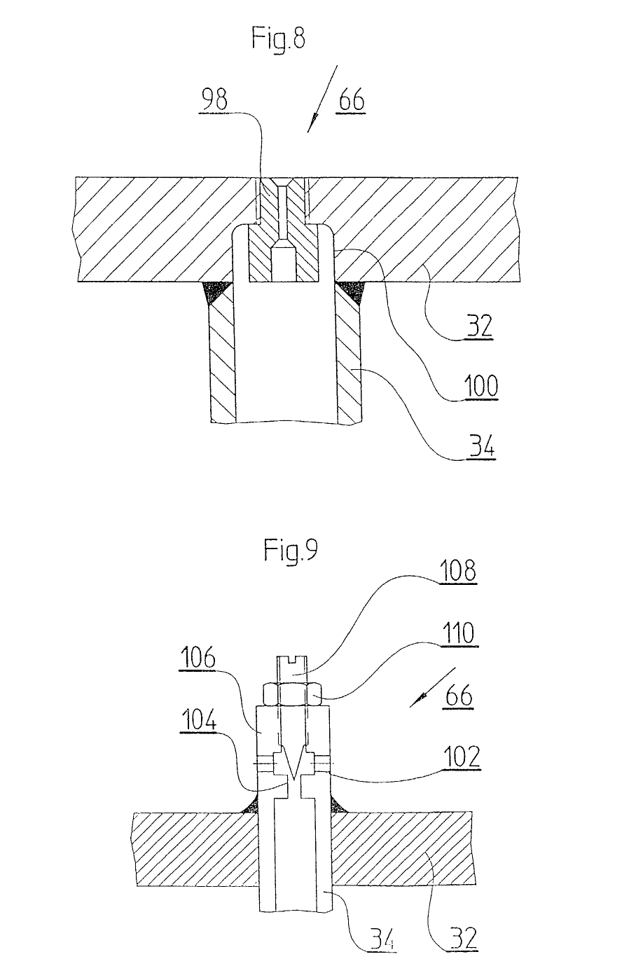

FIG. 8 shows a third exemplary embodiment of the gas inlet to the gas supply tubes,

FIG. 9 shows yet another exemplary embodiment of the gas inlet to the gas supply tubes,

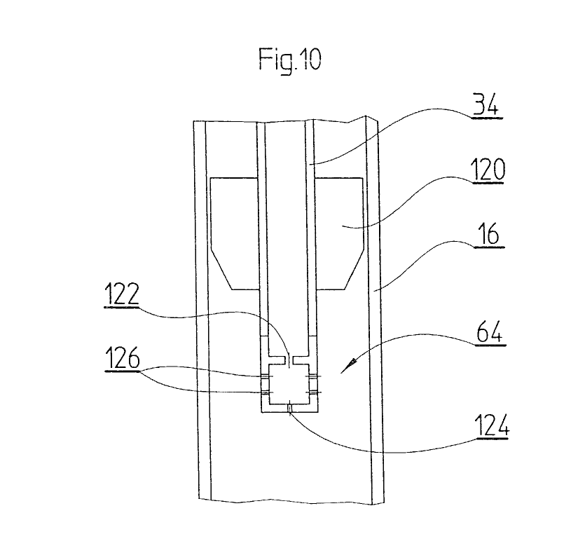

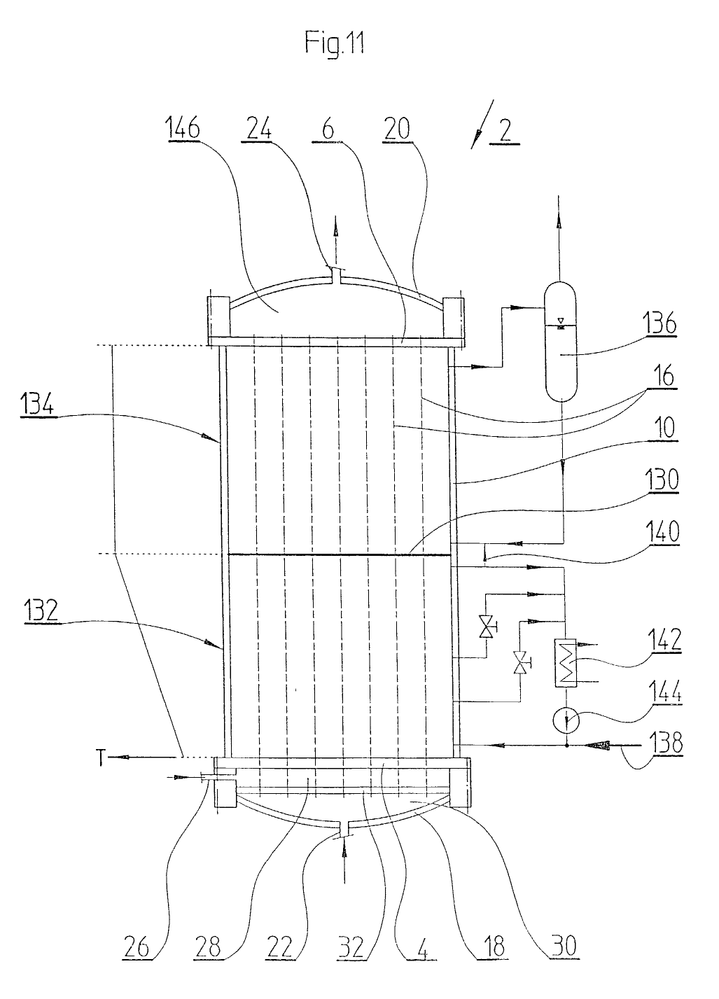

FIG. 10 shows a cross section of a reaction tube with the end of a respective gas supply tube inside the reaction tube, and

FIG. 11 shows schematically a tube reactor according to the invention, similar to that of FIG. 1, however with schematically shown means for a special type of temperature control along the contact tubes.

The tube reactor 2 shown in FIG. 1 contains a reaction tube bundle 8 that stretches in a typically sealed manner between two tube plates 4 and 6 and that is surrounded by a heat carrier, which is in liquid form during operation, typically in the form of a salt bath, inside a surrounding reactor shell 10. In the example shown, a heat carrier enters at the gas outlet side of the reactor shell 10 through a tube socket 12, and exits at the gas inlet side through a tube socket 14; however, the inlet and outlet of the heat carrier can also occur in a known manner using annular grooves, and the heat carrier may pass through the reactor shell 10 in parallel flow instead of countercurrent flow with respect to the reaction gas mixture. Thus, the reaction gas mixture could pass through the reaction tubes 16 from bottom to top instead of, as shown, from top to bottom.

Convex cowls or heads 18 and 20, with central gas inlet and gas outlet sockets 22 and 24, respectively, essentially form the closures of the reactor 2 at the end faces.

However, whereas with conventional tube reactors the cowl on the gas inlet side itself forms one single gas supply chamber that is connected to the reaction tubes 16 in order to supply a final pre-mixed reaction gas, the reactor 2 according to FIG. 1 exhibits a first gas supply chamber 28 that can be fed through a tube socket 26 located to the side and that is inserted between the cowl 18 at the gas inlet side and the tube plate 4 at the gas outlet side for supplying the reaction tubes 16. The gas supply chamber 28 is separated from a second gas supply chamber 30 that is located under the cowl 18 by an additional tube plate 32. Anchored in the tube plate 32 are gas supply tubes 34 that are sealed at the tube plate and which reach down into the reaction tubes 16 and are used for supplying a second gaseous reactant that enters the second gas supply chamber 30 through the gas inlet socket 22. The tube plate 32 is suspended in a sealed manner between a flange 36 on the cylindrical sidewall 38 and a respective flange 40 on the cowl 18. In contrast to the tube plates 4 and 6 that have to carry the weight of the tube bundle 8 and partially also that of the heat carrier that is located inside the reactor shell 10, and that may also have to withstand a greater pressure difference, the tube plate 32 can be made relatively light due to the small pressure differences between the first and the second supplied reactants. This applies all the more if the tube plate 4 has support bars 42, as shown, supporting the tube plate 32.

A transverse gas distribution plate 41 can be provided within the gas supply chamber 30 that may be designed with break-throughs, which vary based on the desired flow distribution, similar to the “baffle discs” 60 and 61 shown in DE-C-2 201 528 (there, however, for the heat carrier).

A centering plate 46, preferably gas-permeable, positioned on the tube plate 4 using legs 44, keeps the bottom ends of the gas supply tubes 34 in a centered position with regard to the reaction tubes 16. If the centering plate 46 has a high gas-permeability, which can easily be realized for such plates, it can also be placed directly onto the tube plate 4. The centering plate 46 is moveable with respect to the gas supply tubes 34. When removing the cowl 18, the tube plate 32 can be removed together with the gas supply tubes 34 and the centering plate 46, which in this case comes to rest at protrusions at the lower ends of the gas supply tubes 34 in order to facilitate the insertion of the gas supply tubes 34 into the corresponding reaction tubes 16 during re-assembly.

When similar elements occur in the subsequently described additional exemplary embodiments, the same reference numerals are used for them that are used for the exemplary embodiment according to FIG. 1.

According to FIG. 2, the volume of the second gas supply chamber 30 is limited by an installation in the form of a plate 50 welded into the cowl 18. The plate 50 is supported at the cowl 18 by means of support rods 52 in the same manner that the tube plate 32 is supported at the tube plate 4 via support rods 54. Whereas the support rods 52 are welded to the cowl 18, the support rods 54 rest loosely on the tube plate 4 for disassembly purposes.

In this case, the supply of the second reactant to the second gas supply chamber 30 is accomplished via a massive central tube 56 that penetrates the cowl 18 and that can also serve as a support for the plate 50 in the cowl 18. As can be seen, the plate 50 is domed with decreasing height toward the outside, which corresponds to the decreasing amount of reactant toward the outside that passes radially through the chamber 30, in order to provide the chamber 30 with the smallest possible volume. As an additional variation compared to FIG. 1, the supply of the first reactant to the first gas supply chamber 28 is carried out from an annular line 58 via numerous radially entering tubes 60 as shown in FIG. 2. This makes it possible to keep a low height, and thus a small volume, for the gas supply chamber 28 as well, in order to be able to quickly cut off the supply of the first reactant—typically a reactive mixture in and of itself—and to maintain a short retention period in the reactor. It is apparent that the probability of self-ignition of a near critical gas mixture increases with the duration of its existence.

Regarding the gas supply tubes 34, two variations are shown on both sides of FIG. 2 that in reality will occur alternatively and not side by side. The left side shows a gas supply tube 34a that reaches into the respective reaction tube 14 and stops directly before the catalyst filling 62 in the tube, while the gas supply tube 34b shown on the right side of FIG. 2 only reaches to the end of the gas inlet side of the corresponding reaction tube 16. Instead of ending freely before the catalyst filling 62, the gas supply tube 34a could, of course, also end inside one of the initial inert material layers.

In both cases shown, a mixture nozzle 64, here in the form of a Venturi tube, can be recognized at the end of the gas supply tube 34, while a flow restrictor 66 is located at the inlet end of the gas supply tube in order to meter the gas inlet to, as well as the gas outlet from, the gas supply tube 34. This metering may also be able to accommodate a radial pressure decrease inside the gas supply chamber 30. The mixture nozzle 64 shall affect an essentially rapid and effective admixing of the second reactant to the first one. It is also possible to provide several such mixture nozzles on the gas supply tube 34.

It is understood that the respective reactor 2 will in reality exhibit significantly more than the two shown reaction tubes 16 and gas supply tubes 34 and that the presentation in FIG. 2 (and the subsequent ones) are for illustrative purposes only.

The design according to FIG. 3 differs from that in FIG. 2 in that here the cowl 18 forms one unit with the gas supply chamber 28 by having a tube plate 32, in the same manner as the plate 50, welded to the cowl 18, or more precisely, to a cylindrical flange ring 68 of the cowl. In this case, in addition to the plate 50, the tube plate 32 is suspended by the support rods 52 as well.

According to FIG. 4, the tube plate 32 has a conical or domed shape, in a similar manner as the plate 50, in order to provide, in addition to the second gas supply chamber 30, the first gas supply chamber 28 with a minimum possible volume, as well for the above stated reasons, and to provide the tube plate 32 with a better stiffness. Aside from that, this embodiment corresponds to a large degree to that of FIG. 3.

According to FIG. 5, a structurally separate, second gas supply chamber 30 is located inside the first gas supply chamber 28, which in this case is formed by a cylindrical flange collar 70 that is connected to the periphery of the tube plate 4 as well as the cowl 18 on the gas inlet side. Feeding the first reactant to the gas supply chamber 28 occurs through a tube socket 72 that is located off-center in the cowl 18, while feeding of the second reactant again occurs through the central tube 56 that penetrates the cowl 18. In this case the central tube 56 is separated for purposes of disassembling the chamber 30.

The tube plate 32 of the second gas supply chamber 30 is attached at a distance above the tube plate 4 using studs 74. A flat bowl 76 that is bolted to the tube plate 32 using hollow studs 78 forms the upper border of the chamber 30. The chamber 30 is therefore passed by the first reactant that enters through the tube socket 72. Furthermore, the first reactant may pass through the hollow studs 78 to find a passage into the reaction tubes 16.

FIGS. 6 to 9 each show how the tube plate 32 of the second gas supply chamber 30 may be welded to a gas supply tube 34 extending into or to the chamber 30 together with the respective flow restrictor 66. According to FIG. 6, the flow restrictor 66 is formed by a chamfered borehole 90 within a face wall 92 of the tube 34; according to FIG. 7 by a collar 94 inside a throughhole 96 of the tube plate 32; according to FIG. 8 by a hollow, appropriately dimensioned threaded nipple 98 inside a set-off throughhole 100 of the tube plate 32; and according to FIG. 9 by an axial borehole 104 that is accessible from the side through a cross hole 102. The flow restricter 66 and is located within a large end section 106 of the respective tube 34 in connection with an—in relation to the borehole 104—axially adjustable stud screw 108 that can be secured in its respective position by a locknut 110.

In FIG. 10 one can recognize the end of the gas supply tube 34 located downstream within the surrounding reaction tube 16. As can be seen, this end is centered in relation to the tube 16 using centering means in the form of wings 120 attached to the tube 16. These wings are chamfered at their face side to facilitate insertion into the tube 16. With regard to the centering plate 46 shown in FIG. 1, the wings 120 may at the same time form the protrusions that the centering plate comes to rest on when the tube plate 32 is removed together with the gas supply tubes 16.

In addition, FIG. 10 shows a mixing nozzle 64 at the end of the gas supply tube 34 that is combined with a flow restrictor 122, which is similar to the flow restrictor 66 described above and which fulfills the same function. Furthermore, the mixing nozzle 64 shown here exhibits, in addition to a gas discharge opening 124 at the face side, several partially successive and partially diametrically opposed, or even distributed in a ring shape, gas discharge openings 126 at the side. With flow restrictors located in the gas supply tube, as shown in FIGS. 6 to 9, such gas discharge locations arranged on the side may also continue to the beginning of the tube or even to outside of the respective reaction tube 16 to achieve a continuous, and as intensive as possible, admixing of the second reactant.

In order to make the mixing ratio of the reactants even more uniform with regard to the entirety of the reaction tubes 16 than is otherwise possible, one may, for example, by using the flow restrictors, already add a partial amount of the second reactant, e.g., O₂, to the first reactant, e.g., ethylene, in a conventional manner up to such an amount that does not yet generate a hazardous mixture prior to the supply of reactor 2. In this manner, the partial amount of the second reactant that is supplied to the reactor 2 through the gas supply tubes 34 can be correspondingly reduced.

It shall be noted that, with regard to the example mentioned, O₂ does not have to be the second reactant that is added through the gas supply tubes. Rather, it is also possible that O₂, or an uncritical ethylene/O₂ mixture, is added as the first reactant via the first gas supply chamber 28 and that ethylene as a second reactant is added via the second gas supply chamber.

FIG. 11 shows, also schematically, a tube reactor 2 that essentially corresponds to the one shown in FIG. 1. However, in this case, the reactor is separated inside the reactor shell 10 by a transverse separator plate 130 into two separate areas 132 and 134 with regard to the heat carrier circuit. As previously mentioned, such measures can be obtained from the aforementioned patent publication DEC-2 201 528 (FIG. 5).

A diagram of the temperature profile within the reactor along the reaction tube 16 is indicated to the left of the shown reactor 2.

Whereas a constant temperature is maintained through evaporation of the heat carrier in section 134, the temperature of the liquid carrier located in the upstream section 132 is allowed to continuously rise beginning at the tube plate 4 at the gas inlet side. This allows for the operation of the reactor, without danger of ignition or explosion, or even the danger of localized overheating. At the location of its occurrence, such operation could lead to an undesirable end reaction, with an even greater load of the reaction gas mixture containing a critical component, such as O₂, for example, than would be possible with the delayed feeding via the gas supply tubes 34 that are supplied from the secondary gas supply chamber 30.

Using suitable designs of the heat carrier circuit, it may, of course, be possible to achieve even more complex temperature profiles along the reaction tubes 16 if desired, possibly in conjunction with several separator plates, such as the separator plate 130 shown in FIG. 11. In general, it can be assumed that the reactivity is highest at the beginning of the reaction tube due to the higher O₂ content. Alone for this reason it is desirable to have a comparatively low temperature at this location. The reactivity decreases in the continued course of the reaction, a condition that can be compensated by increasing the heat carrier temperature. However, starting at a certain degree of reaction, a further temperature increase appears inappropriate. This is the range for working with evaporation.

The accumulating steam is separated from the liquid phase in a separator 136 and provided for other uses, while the liquid heat carrier is re-circulated into the circuit. Otherwise, the heat carrier removed as steam is continuously replaced at 138. For this purpose, the circuits of the reactor sections 132 and 134 are in connection with one another at 140. Element 142 is a cooler and 144 is a pump in the circuit of section 132.

If the same heat carrier is used for both sections, 132 and 134, and even more, if the circuits of both sections are in connection with one another, as shown in FIG. 11, the separator plate 130 does not need to be completely watertight.

It is possible that the reaction gas may still be reactive in the gas discharge chamber 146 under the cowl 20 and can, thus, lead to fire. In such cases it is recommended to cool the reaction gas before its discharge from the reaction tubes 16 using the heat carrier and, in addition, to provide the gas discharge chamber 146 with as small a volume as possible by using inserts, for example, in order to shorten the retention period of the discharge reaction gas in the chamber.

In certain cases, it may also be desirable to switch one or several similar or different types of reactors in series with a reactor according to the invention, with regard to the main reaction gas stream, in order to additionally improve the yield per cycle.

1. A tube reactor (2) for performing exothermic gas phase reactions comprising a reaction tube bundle (8) that extends in a sealed manner between two tube plates (4, 6), that carries a reaction gas mixture through a catalyst filling and is surrounded by a heat carrier inside a surrounding reactor shell (10) and that also includes a cowl (18, 20) that spans the respective tube plates (4, 6) and is connected to a gas inlet and a gas discharge line, characterized in that inside the cowl (18) on the gas inlet side adjacent to a first gas supply chamber (28), connected to the inside of the reaction tubes (16), is located a separately fed second gas supply chamber (30) with its own tube plate (32) that is connected to separate gas supply tubes (34) suitable for a second reaction gas, and in that said separate gas supply tubes reach into the gas inlet end or reach to directly before the gas inlet ends of the reaction tubes (16).

2. A tube reactor (2) as set forth in claim 1, characterized in that at least one of the two gas supply chambers (28, 30) exhibits a significantly smaller volume than the available space under the cowl (18) on the gas inlet side would permit.

3. A tube reactor (2) as set forth in claim 2, characterized in that volume of respective gas supply chambers (28, 30) are reduced as compared to the available volume through at least one insert (50).

4. A tube reactor (2) as set forth in claim 3, characterized in that the insert consists of a plate (50) that is welded into the cowl (18) on the gas inlet side and that extends in a transverse direction.

5. A tube reactor (2) as set forth in claim 4, characterized in that the plate (50) is additionally supported in its center area at the cowl (18) on the gas inlet side.

6. A tube reactor (2) as set forth in claim 5, characterized in that the support is at least partially formed by a relatively large central gas supply tube (56).

7. A tube reactor (2) as set forth in one of the claims 4 to 6, characterized in that the plate (50) and possibly also the tube plate (32) of the second gas supply chamber (30) exhibits essentially a domed or conical shape.

8. A tube reactor (2) as set forth in one of the previous claims, characterized in that the tube plate (32) of the second gas supply chamber (30) is supported against the tube plate (4) of the reaction tube bundle (8) at the gas inlet side and/or against the cowl (18) at the gas inlet side.

9. A tube reactor (2) as set forth in one of the previous claims, characterized in that the tube plate (32) of the second gas supply chamber (30) is suspended between a flange (40) of the cowl (18) on the gas inlet side and a flange (36) that is connected to the reactor shell (10).

10. A tube reactor (2) as set forth in one of claims 1 to 8, characterized in that the tube plate 32 of the second gas supply chamber (30) is attached together with the same in a detachable manner to the tube plate (4) at the gas inlet side of the reaction tube bundle (8).

11. A tube reactor (2) as set forth in one of claims 1 to 8, characterized in that the entire second gas supply chamber (30) is integrated with the cowl (18) on the gas inlet side.

12. A tube reactor (2) as set forth in one of the previous claims, characterized in that the second gas supply chamber (30) together with the attached gas supply tubes (34) can be detached in the same manner as the cowl (18) on the gas inlet side.

13. A tube reactor (2) as set forth in one of the previous claims, characterized in that at least one of the two gas supply chambers (28, 30) exhibits a gas distribution plate (41) with break-throughs of various cross-sections.

14. A tube reactor (2) as set forth in one of the previous claims, characterized in that at least one of the two gas supply chambers (28, 30) exhibits an increasing or decreasing height with regard to the flow distribution, beginning at the longitudinal center axis of the reactor.

15. A tube reactor (2) as set forth in one of the previous claims, characterized in that, prior to entering into the reaction tubes (16), the gas supply tubes (34) pass through a, preferably gas-permeable, centering plate (46).

16. A tube reactor (2) as set forth in claim 15, characterized in that the centering plate (46) can be moved on the gas supply tubes (34) essentially to their free ends.

17. A tube reactor (2) as set forth in one of the previous claims, characterized in that the gas supply tubes (34) exhibit at their free ends centering means (120) for centering said tubes in relation to the associated reaction tubes (16).

18. A tube reactor (2) as set forth in one of the previous claims, characterized in that the gas supply tubes (34) include mixing nozzles (64) at least at their free ends for mixing the second reactant that is fed through said gas supply tubes with the first reactant.

19. A tube reactor (2) as set forth in one of the previous claims, characterized in that the gas supply tubes (34) include, preferably at their inlet, a, possibly adjustable, flow restrictor for metering the flow that exits from it.

20. A tube reactor (2) as set forth in claims 18 and 19, characterized in that flow restrictor forms a unit with the mixing nozzle (64).

21. A tube reactor (2) as set forth in one of the previous claims, characterized in that the gas supply tubes (34) each exhibit several gas discharge locations distributed across their lengths.

22. A tube reactor (2) as set forth in claim 21, characterized in that the respective gas discharge locations are still partially located outside of the reaction tubes (16).

23. A tube reactor (2) as set forth in one of the previous claims, characterized in that the gas supply tubes (34) end before reaching the catalyst filling (62) contained in the respective reaction tube (16).

24. A tube reactor (2) as set forth in claim 23, characterized in that the gas supply tubes (34) end in an inert material layer that is located ahead of the catalyst filling (62) in the direction of flow.

25. A tube reactor (2) as set forth in one of the previous claims, characterized in that the heat carrier circuit is designed such that the operating temperature increases along the reaction tubes (16) from a relative low value at the gas inlet end of the reaction tubes (16).

26. A tube reactor (2) as set forth in claim 25, characterized in that the heat carrier circuit is additionally designed so as to maintain the operating temperature in a section of the reaction tubes (16) that is further downstream in the direction of flow.

27. A tube reactor (2) as set forth in claim 26, characterized in that an evaporation of the heat carrier occurs in the area of the respective tube section.

28. A tube reactor (2) as set forth in one of the previous claims, characterized in that the heat carrier circuit is designed so as to lower the operating temperature in the region of the gas discharge end of the reaction tubes (16).

29. A tube reactor (2) as set forth in one of the previous claims, characterized in that a gas discharge chamber (146) within the cowl (20) on the gas discharge side has a volume as low as possible by using inserts or the like.

30. A tube reactor (2) as set forth in one of the previous claims, characterized in that a portion of the second reactant that is fed into the reaction tubes is already admixed with the first reactant prior to entering the reactor.

31. A tube reactor (2) as set forth in one of the previous claims, characterized in that one or more similar or different types of reactors are connected in series with said reactor, with regard to the main reaction gas stream.
